(19) United States
(12) Patent Application Publication
(10) Pub. No.: US 2025/0135791 A1
(43) Pub. Date: May 1, 2025

(54) PRINTING APPARATUS

(71) Applicant: SEIKO EPSON CORPORATION, TOKYO (JP)

(72) Inventor: Daigo USUI, SHIOJIRI-SHI (JP)

(21) Appl. No.: 18/928,714

(22) Filed: Oct. 28, 2024

(30) Foreign Application Priority Data
Oct. 27, 2023 (JP) 2023-184498

(51) Int. Cl. B41J 11/00; B41J 13/10; B41J 29/00; G03G 15/00

(52) U.S. Cl. CPC B41J 11/0095; B41J 13/103; B41J 29/00; G03G 15/5016; G03G 15/5029; G03G 15/5087; G03G 15/5095; G03G 15/6508; G03G 2215/00734

(57) ABSTRACT

When a control unit receives a print request to designate a first size as a size of a sheet and designate a first material as a material of the sheet and a size of the sheet held by a sheet feeding cassette is a second size and a material of the sheet is a second material, the control unit displays a first display in one of a first mode and a second mode different from the first mode based on the first size and the second size, and displays a second display in one of a third mode and a fourth mode different from the third mode based on the first material and the second material.

The present application is based on, and claims priority from JP Application Serial Number 2023-184498, filed Oct. 27, 2023, the disclosure of which is hereby incorporated by reference herein in its entirety.

### BACKGROUND

### 1. Technical Field

The present disclosure relates to a printing apparatus.

### 2. Related Art

In related art, there is known an apparatus that displays a warning when a printing apparatus fails to execute printing.

For example, in an information processing apparatus disclosed in JP-A-2023-53990, a print conversion utility, which is used for printing by a printer not configured to interpret printing data in a format according to an OS standard printing function, is installed. The information processing apparatus acquires print setting information of a printing apparatus not configured to interpret printing data in a predetermined format, and acquires print setting information set in OS standard printing software. When the print setting information of the printing apparatus does not correspond to the print setting information set in the OS standard printing software, the information processing apparatus delivers a warning message.

JP-A-2023-53990 is an example of the related art.

However, even when the warning message is displayed, settings for a printing medium include a plurality of setting items and a user may not immediately recognize which setting of the printing medium causes an error.

### SUMMARY

A printing apparatus according to an aspect of the present disclosure includes a display unit, a receiving unit receiving a print request, a medium container unit holding a printing medium, a size detection unit detecting a size of the printing medium held in the medium container unit, and a control unit controlling the display unit to display a first display relating to the size of the printing medium and a second display relating to a material of the printing medium, wherein, when the print request to designate a first size as the size of the printing medium and designate a first material as the material of the printing medium is received and the size of the printing medium held in the medium container unit is a second size and a material of the printing medium is a second material, the control unit displays the first display in one of a first mode and a second mode different from the first mode based on the first size and the second size, and the control unit displays the second display in one of a third mode and a fourth mode different from the third mode based on the first material and the second material. A printing apparatus according to an aspect of the present disclosure includes a display unit, a receiving unit receiving a print request, a medium container unit holding a printing medium, a size detection unit detecting a size of the printing medium held in the medium container unit, and a control unit controlling the display unit to display a first display relating to the size of the printing medium and a second display relating to a material of the printing medium, wherein, when the print request to designate a first size as the size of the printing medium and designate a first material as the material of the printing medium is received and the size of the printing medium held in the medium container unit is a second size different from the first size and a material of the printing medium is a second material different from the first material, the control unit displays the first display in a second mode and displays the second display in a fourth mode, when the size detection unit detecting the size of the printing medium held in the medium container unit detects that the size of the printing medium held in the medium container unit is changed from the second size to the first size, the control unit continues the display of the second display in the fourth mode and changes the mode of the first display from the second mode to a first mode different from the second mode, and when a setting of the material of the printing medium held in the medium container unit is changed from the second material to the first material, the control unit continues the display of the first display in the first mode and changes the mode of the second display from the fourth mode to a third mode different from the fourth mode.

### BRIEF DESCRIPTION OF THE DRAWINGS

FIG. 1 is a block diagram showing a configuration of a multifunction peripheral.

FIG. 2 shows an example of a status window.

FIG. 3 shows an example of the status window.

FIG. 4 shows an example of the status window.

FIG. 5 shows an example of the status window.

FIG. 6 shows an example of a setting change window.

FIG. 7 shows an example of a list window.

FIG. 8 is a flowchart showing an operation of the multifunction peripheral.

FIG. 9 is a flowchart showing the operation of the multifunction peripheral.

### DESCRIPTION OF EMBODIMENTS

As below, embodiments of the present disclosure will be described with reference to the drawings.

### 1. Configuration of Multifunction Peripheral

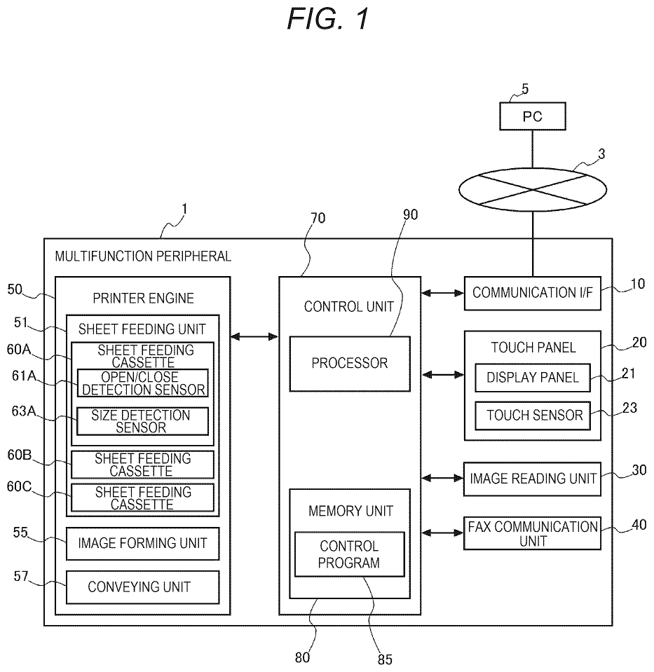

FIG. 1 is a block diagram showing a configuration of a multifunction peripheral 1.

The configuration of the multifunction peripheral 1 will be described with reference to FIG. 1. The multifunction peripheral 1 corresponds to a printing apparatus. The multifunction peripheral 1 includes a communication interface 10, a touch panel 20, an image reading unit 30, a facsimile communication unit 40, a printer engine 50, and a control unit 70. Hereinafter, the interface is abbreviated as I/F, and the facsimile is abbreviated as FAX.

The communication I/F 10 corresponds to a receiving unit. The communication I/F 10 includes a communication module such as a LAN (local area network) card. The communication I/F 10 is coupled to a network 3 and performs mutual data communication with a personal computer 5 and the like coupled to the network 3. Hereinafter, the personal computer is abbreviated as PC.

The touch panel 20 corresponds to a display unit and a reception unit. The touch panel 20 includes a display panel 21 such as a liquid crystal panel or an organic EL (Electro Luminescence) panel, and a touch sensor 23 superimposed on the display panel 21. The touch sensor 23 detects a touch operation in a position of the touch panel 20 touched by a user's finger. The touch sensor 23 outputs an operation signal containing coordinate information indicating the detected position of the touch panel 20 to the control unit 70. The touch panel 20 may include hardware buttons.

The image reading unit 30 reads an image of a document to generate image data, and outputs the generated image data to the control unit 70. The control unit 70 stores the input image data in a memory unit 80, prints the image data on a sheet using the printer engine 50, and transmits the image data to a destination set by the user by facsimile communication using the facsimile communication unit 40.

The FAX communication unit 40 acquires the image data from the control unit 70 and transmits the acquired image data to a designated destination by FAX via a public telephone line. The FAX communication unit 40 receives the image data transmitted by FAX from another apparatus via the public telephone line.

The printer engine 50 includes a sheet feeding unit 51, an image forming unit 55, and a conveying unit 57.

The sheet feeding unit 51 includes a plurality of sheet feeding cassettes 60. The sheet feeding cassette 60 corresponds to a medium container unit. The sheet feeding cassette 60 holds sheet as a printing medium. In the embodiment, a case where the sheet feeding unit 51 includes three sheet feeding cassettes 60 of a first sheet feeding cassette 60A, a second sheet feeding cassette 60B, and a third sheet feeding cassette 60C is described, however, the number of sheet feeding cassettes 60 provided in the sheet feeding unit 51 is not limited to three, but may be four or more. The first sheet feeding cassette 60A, the second sheet feeding cassette 60B, and the third sheet feeding cassette 60C are collectively referred to as the sheet feeding cassette 60.

The image forming unit 55 forms an image on a sheet. For example, in an inkjet system, the image forming unit 55 includes an inkjet head and a head drive mechanism. In an electrophotographic system, the image forming unit 55 includes a photosensitive drum, and a charging device, an exposure device, a developing device, and a transfer roller arranged around the photosensitive drum.

The conveying unit 57 conveys the sheet held in the sheet feeding unit 51 to an image forming position of the image forming unit 55, and conveys the sheet with an image formed thereon to an eject tray (not shown) and ejects the sheet.

Each sheet feeding cassette 60 includes an open/close detection sensor 61 and a size detection sensor 63. The size detection sensor 63 corresponds to a size detection unit.

Although FIG. 1 only shows an open/close detection sensor 61A and a size detection sensor 63A for the first sheet feeding cassette 60A because of space limitations, the second sheet feeding cassette 60B and the third sheet feeding cassette 60C similarly include open/close detection sensors 61B and 61C and size detection sensors 63B and 63C, respectively.

The open/close detection sensor 61 is a sensor that detects whether the sheet feeding cassette 60 is pulled out from the main body of the multifunction peripheral 1 and opened or the sheet feeding cassette 60 is inserted into the main body of the multifunction peripheral 1 and closed. When the sheet feeding cassette 60 is opened, the user can replenish or replace sheets. When the sheet feeding cassette 60 is closed, the conveying unit 57 can convey the sheet to the image forming position.

The size detection sensor 63 detects a size of the sheet held in the sheet feeding cassette 60 and an orientation of the sheet. The orientation of the sheet detected by the size detection sensor 63 includes “portrait orientation” in which the long side of the rectangular sheet is longitudinally oriented and “landscape orientation” in which the long side is laterally oriented. As the size detection sensor 63, for example, a mechanism that detects the size of the sheet and the orientation of the sheet from a position of a movable guide member in contact with the outer peripheral portion of the sheet is used. As another example, the size detection sensor 63 can detect the size of the sheet and the orientation of the sheet by optical means.

The control unit 70 is a computer including the memory unit 80 and a processor 90.

The memory unit 80 includes at least a nonvolatile memory device. The memory unit 80 may include a volatile memory device in addition to the non-volatile memory device. The memory unit 80 includes, for example, a ROM (Read Only Memory), a flash memory, and an EEPROM (Electrically Erasable Programmable Read-Only Memory).

The memory unit 80 stores a control program 85 executed by the processor 90. The memory unit 80 is used as a calculation area of the processor 90.

The processor 90 is an arithmetic processing device including a processor such as a CPU (Central Processing Unit) or an MPU (Micro-Processing Unit). The processor 90 may include a single processor or a plurality of processors. The processor 90 may include an SoC (System-on-a-chip) integrated with part or all of the memory unit 80 or another circuit. The processor 90 may include a combination of a CPU that executes a program and a DSP (Digital Signal Processor) that executes predetermined arithmetic processing. Further, all functions of the processor 90 may be implemented in hardware, or a programmable device may be used.

### 2. Operation of Multifunction Peripheral

The processor of the PC 5 executes an application program installed in the PC 5 and generates a job according to a user operation. The PC 5 transmits the generated job to the multifunction peripheral 1. The job corresponds to a print request.

The multifunction peripheral 1 receives the job transmitted from the PC 5 through the communication I/F 10. The communication I/F 10 outputs the received job to the control unit 70.

The job includes information of the size of the sheet for printing, the orientation of the image, the material of the sheet for printing, the number of copies to be printed, the setting of single-sided printing or double-sided printing, and the like in addition to the image data to be printed on the sheet. These pieces of information are collectively referred to as job setting information. The size of the sheet contained in the job setting information corresponds to a first size. The material of the sheet contained in the job setting information corresponds to a first material.

When the job is input from the communication I/F 10, the control unit 70 of the multifunction peripheral 1 compares the job setting information of the input job with the information of the sheet held in the sheet feeding cassette 60. The information on the sheets held in the sheet feeding cassette 60 is hereinafter referred to as cassette setting information. The cassette setting information includes the size and orientation of the sheet and the material of the sheet held in the corresponding sheet feeding cassette 60. The size and orientation of the sheet contained in the cassette setting information are information detected by the size detection sensor 63 when the open/close detection sensor 61 detects open/close of the sheet feeding cassette 60. The sheet material contained in the cassette setting information is information input by the user operating the touch panel 20. The sheet size contained in the cassette setting information corresponds to a second size. The material of the sheet contained in the cassette setting information corresponds to a second material. The cassette setting information is information stored in the memory unit 80 and corresponds to setting information. The multifunction peripheral 1 includes three sheet feeding cassettes 60 of the first sheet feeding cassette 60A, the second sheet feeding cassette 60B, and the third sheet feeding cassette 60C. Accordingly, the cassette setting information is set for each of the three sheet feeding cassettes 60 of the first sheet feeding cassette 60A, the second sheet feeding cassette 60B, and the third sheet feeding cassette 60C.

The cassette setting information to be compared with the job setting information may be, for example, cassette setting information of the sheet feeding cassette 60 set to feed sheets by default, or cassette setting information of the sheet feeding cassette 60 set by the user through the operation of the touch panel 20. Here, a case where the cassette setting information of the sheet feeding cassette 60 set to feed sheets by default is compared with the job setting information will be described.

The control unit 70 determines whether the size and orientation of the sheet contained in the job setting information is the same as the size and orientation of the sheet contained in the cassette setting information. The control unit 70 determines whether the material of the sheet contained in the job setting information is the same as the material of the sheet contained in the cassette setting information.

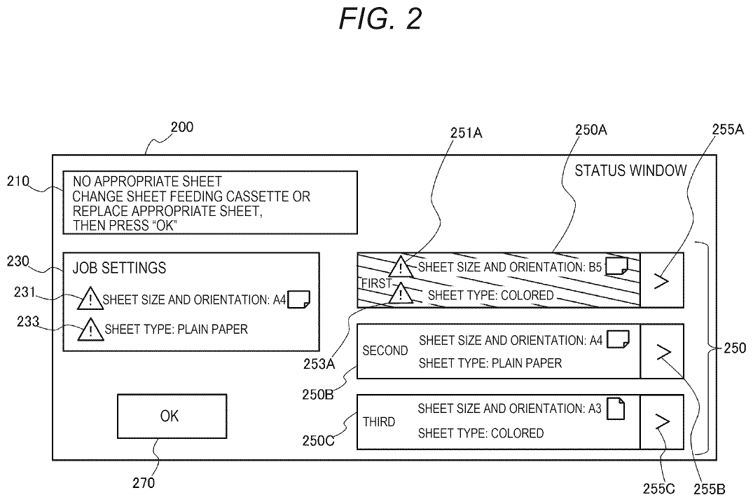

FIGS. 2 to 4 show examples of display of a status window 200 when the job setting information and the cassette setting information are different.

FIG. 2 shows the status window 200 when the sheet size and orientation of the job setting information and the sheet size and orientation of the cassette setting information are different and a sheet type of the job setting information and a sheet type of the cassette setting information are different.

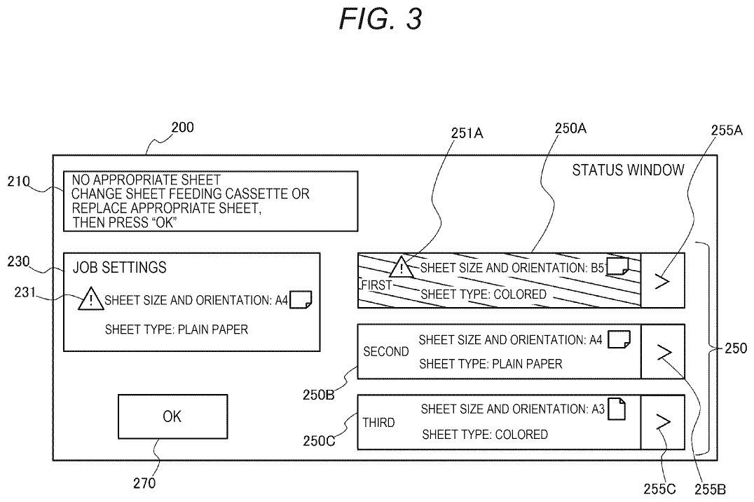

FIG. 3 shows the status window 200 when the sheet size and orientation of the job setting information and the sheet size and orientation of the cassette setting information are different and the sheet type of the job setting information and the sheet type of the cassette setting information are the same.

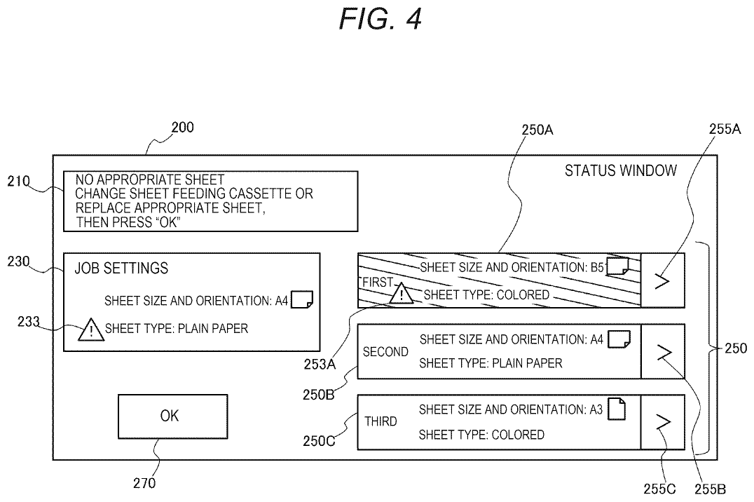

FIG. 4 shows the status window 200 when the sheet size and orientation of the job setting information and the sheet size and orientation of the cassette setting information are the same and the sheet type of the job setting information and the sheet type of the cassette setting information are different.

When the size, orientation, and material of the sheet contained in the job setting information and the size, orientation, and material of the sheet contained in the cassette setting information are not completely the same, the control unit 70 displays the status window 200 on the touch panel 20. The status window 200 is a window for the user to check the status with respect to the sheet and the status window 200 displays a first display field 210, a second display field 230, a third display field 250, and a completion button 270.

In the first display field 210, guidance for the user to be notified is displayed.

The guidance displays that the sheet having the same size, orientation, and material as those designated by the job is not held in the sheet feeding cassette 60. Further, the guidance displays guidance to change the sheet feeding cassette 60 or to supply a sheet having the same size, orientation, and material as those of the sheet designated by the job in the sheet feeding cassette 60. Furthermore, the guidance displays guidance to press the completion button 270 after the sheet supply in the sheet feeding cassette 60 is completed.

The second display field 230 displays the size and orientation of the sheet and the material of the sheet contained in the job setting information. Although FIGS. 2 to 4 show the examples in which the size and orientation of the sheet are displayed in the second display field 230, the orientation of the sheet is not essential and the orientation of the sheet is not necessarily displayed in the second display field 230.

A first error icon 231 and a second error icon 233 indicating that errors occur are displayed in the second display field 230. The first error icon 231 corresponds to a first object, and the second error icon 233 corresponds to a third object.

The first error icon 231 is an icon displayed when the size and orientation of the sheet in the job setting information and the size and orientation of the sheet in the cassette setting information are different. The second error icon 233 is an icon displayed when the material of the sheet of the job setting information and the material of the sheet of the cassette setting information are different.

The first error icon 231 is displayed to accompany the size and orientation of the sheet displayed in the second display field 230. The second error icon 233 is displayed to accompany the material of the sheet displayed in the second display field 230. The expression “displayed to accompany” means that these objects are displayed side by side without another object in between or displayed in the same frame.

FIGS. 2 to 4 show a case where exclamation marks are displayed as the first error icon 231 and the second error icon 233, however, the first error icon 231 and the second error icon 233 may be other figures or symbols or may be texts for calling the user's attention.

The size and orientation of the sheet displayed in the second display field 230 and the first error icon 231 correspond to a first display. The material of the sheet displayed in the second display field 230 and the second error icon 233 correspond to a second display.

The third display field 250 displays cassette setting information of the plurality of sheet feeding cassettes 60 provided in the multifunction peripheral 1.

The third display field 250 displaying the cassette setting information of the first sheet feeding cassette 60A is referred to as a third display field 250A.

The third display field 250 displaying the cassette setting information of the second sheet feeding cassette 60B is referred to as a third display field 250B.

The third display field 250 displaying the cassette setting information of the third sheet feeding cassette 60C is referred to as a third display field 250C.

The third display field 250A displays the size and orientation of the sheet and the material of the sheet of the cassette setting information set for the first sheet feeding cassette 60A.

The third display field 250B displays the size and orientation of the sheet and the material of the sheet of the cassette setting information set for the second sheet feeding cassette 60B.

The third display field 250C displays the size and orientation of the sheet and the material of the sheet of the cassette setting information set in the third sheet feeding cassette 60C.

Although FIGS. 2 to 4 show the examples in which the size and orientation of the sheet are displayed in the third display field 250, the orientation of the sheet is not essential and the orientation of the sheet is not necessarily displayed in the third display field 250.

In addition, among the third display fields 250A, 250B, and 250C, the third display field 250 corresponding to the sheet feeding cassette 60 set to feed sheets to the image forming unit 55 for processing of the received job is displayed in a form different from those of the other third display fields 250. In the status window 200 shown in FIGS. 2 to 4, the hatched third display field 250A is lighted and the third display fields 250B and 250C are not.

Further, a third error icon 251 and a fourth error icon 253 indicating that errors occur are each displayed in the third display field 250 corresponding to the sheet feeding cassette 60 set to feed sheets to the image forming unit 55 for processing of the received job. The third error icon 251 corresponds to a second object, and the fourth error icon 253 corresponds to a fourth object.

The third error icon 251 is an icon displayed when the size and orientation of the sheet in the cassette setting information and the size and orientation of the sheet in the job setting information are different. The fourth error icon 253 is an icon displayed when the material of the sheet of the cassette setting information and the material of the sheet of the job setting information are different.

The third error icon 251 is displayed to accompany the size and orientation of the sheet displayed in the third display field 250. The fourth error icon 253 is displayed to accompany the material of the sheet displayed in the third display field 250. The expression “displayed to accompany” means that these objects are displayed side by side without another object in between or displayed in the same frame.

Although FIGS. 2 to 4 show a case where exclamation marks are displayed as the third error icon 251 and the fourth error icon 253, the third error icon 251 and the fourth error icon 253 may be other figures or symbols or may be texts for calling the user's attention.

Note that, in FIG. 2, the third error icon 251 and the fourth error icon 253 are displayed only in the third display field 250A, but the third error icon 251 and the fourth error icon 253 are not displayed in the third display fields 250B and 250C.

The third error icon 251 and the fourth error icon 253 are displayed only in the third display field 250A because the first sheet feeding cassette 60A is set as the sheet feeding cassette 60 set to feed sheets to the image forming unit 55. For example, when the second sheet feeding cassette 60B is set as the sheet feeding cassette 60 set to feed sheets to the image forming unit 55, the third error icon 251 and the fourth error icon 253 are displayed in the third display field 250B. The sheet feeding cassette 60 set to feed sheets to the image forming unit 55 is designated in advance by the user in the job setting information.

The error icons displayed in the third display field 250A are referred to as a third error icon 251A and a fourth error icon 253A, and the error icons displayed in the third display field 250B are referred to as a third error icon 251B and a fourth error icon 253B. The error icons displayed in the third display field 250C are referred to as a third error icon 251C and a fourth error icon 253C.

The size and orientation of the sheet displayed in the third display field 250 and the third error icon 251 correspond to the first display. The material of the sheet displayed in the third display field 250 and the fourth error icon 253 correspond to the second display.

The status window 200 as shown in FIG. 2 in which the first error icon 231 is displayed, the second error icon 233 is displayed, the third error icon 251 is displayed, and the fourth error icon 253 is displayed can be referred to as a first status window.

The status window 200 as shown in FIG. 3 in which the first error icon 231 is displayed, the second error icon 233 is hidden, the third error icon 251 is displayed, and the fourth error icon 253 is hidden can be referred to as a second status window.

The status window 200 as shown in FIG. 4 in which the first error icon 231 is hidden, the second error icon 233 is displayed, the third error icon 251 is hidden, and the fourth error icon 253 is displayed can be referred to as a third status window.

When the size and orientation of the sheet contained in the job setting information and the size and orientation of the sheet contained in the cassette setting information are different, the control unit 70 displays the first error icon 231 and the third error icon 251 as shown in FIG. 2 or FIG. 3. The first error icon 231 and the third error icon 251 in the displayed state correspond to a second display mode.

When the size and orientation of the sheet contained in the job setting information and the size and orientation of the sheet contained in the cassette setting information are different, the first error icon 231 and the third error icon 251 may be blinked or displayed in display colors different from those of the first mode.

When the size and orientation of the sheet contained in the job setting information and the size and orientation of the sheet contained in the cassette setting information are the same, the control unit 70 hides the first error icon 231 and the third error icon 251. The first error icon 231 and the third error icon 251 in the hidden state correspond to a first display mode.

When the size and orientation of the sheet contained in the job setting information and the size and orientation of the sheet contained in the cassette setting information are the same, the first error icon 231 and the third error icon 251 may be displayed in display colors different from those of the second mode. Further, the first error icon 231 and the third error icon 251 may be displayed when the size and the orientation of the sheet contained in the job setting information and the size and the orientation of the sheet contained in the cassette setting information are the same, and the first error icon 231 and the third error icon 251 may be hidden when the size and the orientation and the size and the orientation of the sheet contained in the cassette setting information are different.

When the material of the sheet contained in the job setting information and the material of the sheet contained in the cassette setting information are different, the control unit 70 displays the second error icon 233 and the fourth error icon 253 as shown in FIG. 2 or FIG. 4. The second error icon 233 and the fourth error icon 253 in the displayed state correspond to a fourth display mode.

When the material of the sheet contained in the job setting information and the material of the sheet contained in the cassette setting information are different, the second error icon 233 and the fourth error icon 253 may be blinked, or may be displayed in display colors different from those of the third mode.

When the material of the sheet contained in the job setting information and the material of the sheet contained in the cassette setting information are the same, the control unit 70 hides the second error icon 233 and the fourth error icon 253. The second error icon 233 and the fourth error icon 253 in the hidden state correspond to a third display mode.

When the material of the sheet contained in the job setting information and the material of the sheet contained in the cassette setting information are the same, the second error icon 233 and the fourth error icon 253 may be displayed in display colors different from those of the fourth mode.

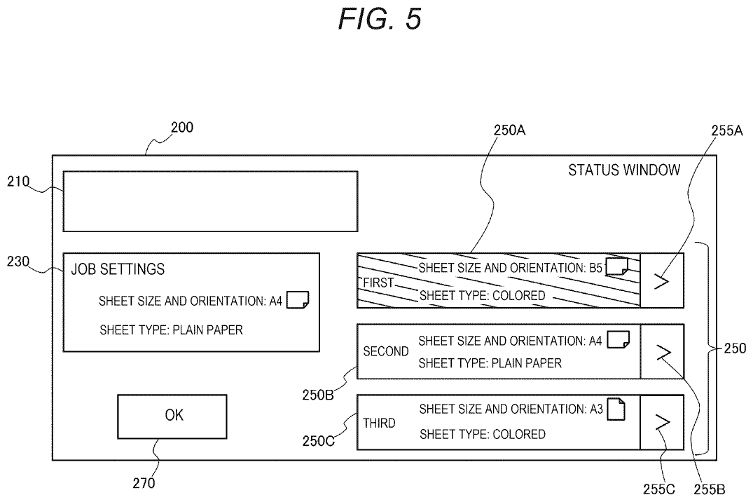

FIG. 5 shows the status window 200 when the error is resolved. That is, FIG. 5 shows the status window 200 when the sheet size and orientation of the job setting information and the sheet size and orientation of the cassette setting information are the same and the sheet type of the job setting information and the sheet type of the cassette setting information are the same.

With the status window 200 shown in any one of FIGS. 2 to 4 is displayed on the touch panel 20 and at least one of the size and the orientation of the sheet detected by the size detection sensor 63 and the setting of the material of the sheet by the operation of the touch panel 20 is changed and the size, the orientation, and the material of the sheet contained in the job setting information and the size, the orientation, and the material of f the sheet contained in the cassette setting information become the same, the control unit 70 hides all of the first error icon 231, the second error icon 233, the third error icon 251, and the fourth error icon 253 as shown in FIG. 5.

The status window 200 as shown in FIG. 5 in which the first error icon 231 is hidden, the second error icon 233 is hidden, the third error icon 251 is hidden, and the fourth error icon 253 is hidden can be referred to as a fourth status window. The display of the first to fourth status windows as described above is switched under control of the control unit 70 based on the cassette setting information and the job setting information.

Further, a setting change button 255 is displayed in the third display field 250. In FIGS. 2 to 5, the setting change button 255 is represented by “>”. The setting change button 255 displayed in the third display field 250A is referred to as a setting change button 255A, and the setting change button 255 displayed in the third display field 250B is referred to as a setting change button 255B. The setting change button 255 displayed in the third display field 250C is referred to as a setting change button 255C. The setting change buttons 255A, 255B, and 255C are collectively referred to as the setting change button 255.

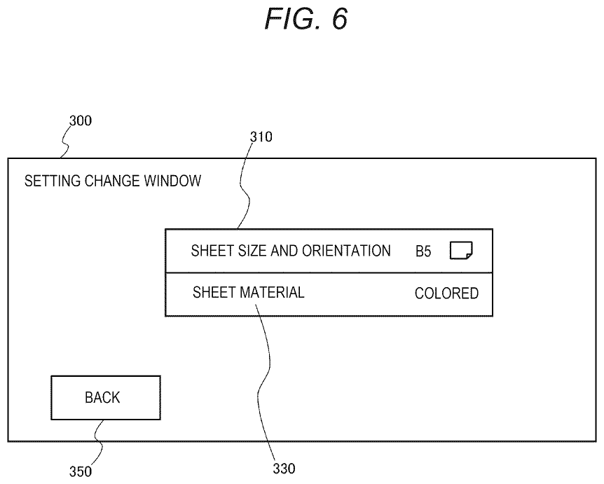

When the setting change button 255 is pressed, the control unit 70 displays a setting change window 300 shown in FIG. 6 on the touch panel 20.

FIG. 6 shows an example of the setting change window 300.

The control unit 70 updates the cassette setting information based on the detection result of the size detection sensor 63. That is, the size and orientation of the sheet stored in the sheet feeding cassette 60 are automatically detected by the size detection sensor 63. The control unit 70 determines whether at least one of the size and the orientation of the sheet detected by the size detection sensor 63 is changed before and after the open/close detection sensor 61 detects attachment of the sheet feeding cassette 60. When at least one of the size and the orientation of the sheet is changed, the control unit 70 updates the cassette setting information of the corresponding sheet feeding cassette 60.

The control unit 70 determines whether the changed size and orientation of the sheet in the cassette setting information and the size and orientation of the sheet in the job setting information are the same. When the size and orientation of the sheet in the cassette setting information and the size and orientation of the sheet in the job setting information are the same, the control unit 70 hides the display of the first error icon 231 and the third error icon 251 in the status window 200.

However, the multifunction peripheral 1 is not equipped with a sensor for detecting the material of the sheet. Accordingly, when the status window 200 is displayed on the touch panel 20, the user is required to perform an operation of pressing the setting change button 255 displayed in the status window 200 to display the setting change window 300 and changing the material of the sheet held in the corresponding sheet feeding cassette 60.

A first display field 310, a second display field 330, and a return button 350 are displayed in the setting change window 300. The return button 350 is a button for receiving an operation to return to the status window 200.

The first display field 310 displays the setting of the size and orientation of the sheet. The second display field 330 displays the setting of the material of the sheet.

For example, for changing the material of the sheet, the user selects the second display field 330 by a touch operation. When the second display field 330 is selected, the control unit 70 displays a list window 400 that displays a list of selectable sheet materials.

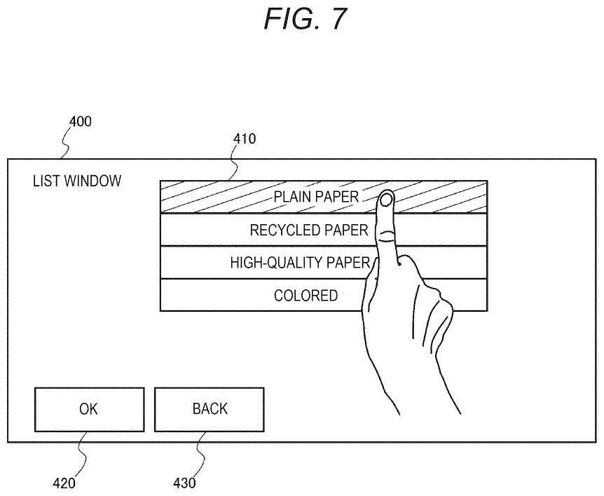

FIG. 7 shows an example of the list window 400.

The list window 400 displays a material select field 410, an enter button 420, and a return button 430. A list of selectable sheet materials is displayed in the material select field 410.

The enter button 420 is a button pressed when any one of the sheet materials displayed in the material select field 410 is selected and the selected sheet material is determined.

The return button 430 is pressed to return to the setting change window 300 shown in FIG. 6 without changing the sheet material.

When receiving the operation of changing the sheet material in the list window 400, the control unit 70 updates the cassette setting information of the corresponding sheet feeding cassette 60. That is, the sheet material accepted in the list window 400 is registered as the cassette setting information and stored in the memory unit 80.

Then, the control unit 70 determines whether the changed sheet material of the cassette setting information and the material of the sheet of the job setting information are the same. When the material of the sheet in the cassette setting information and the material of the sheet in the job setting information are the same, the control unit 70 hides the second error icon 233 and the fourth error icon 253 in the status window 200.

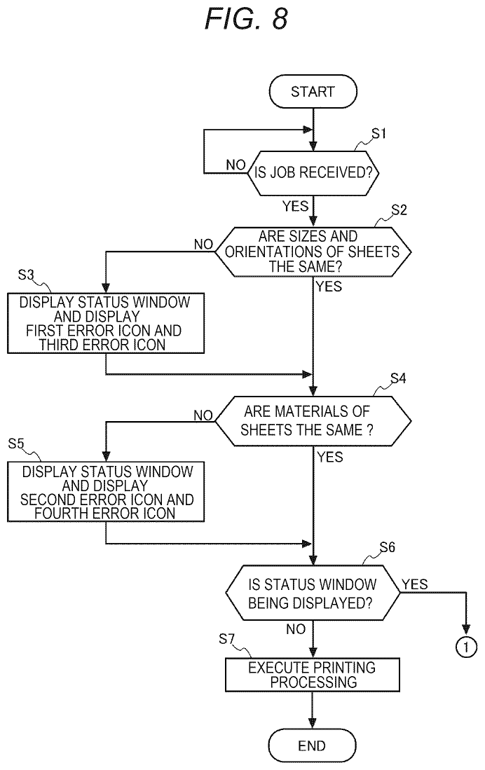

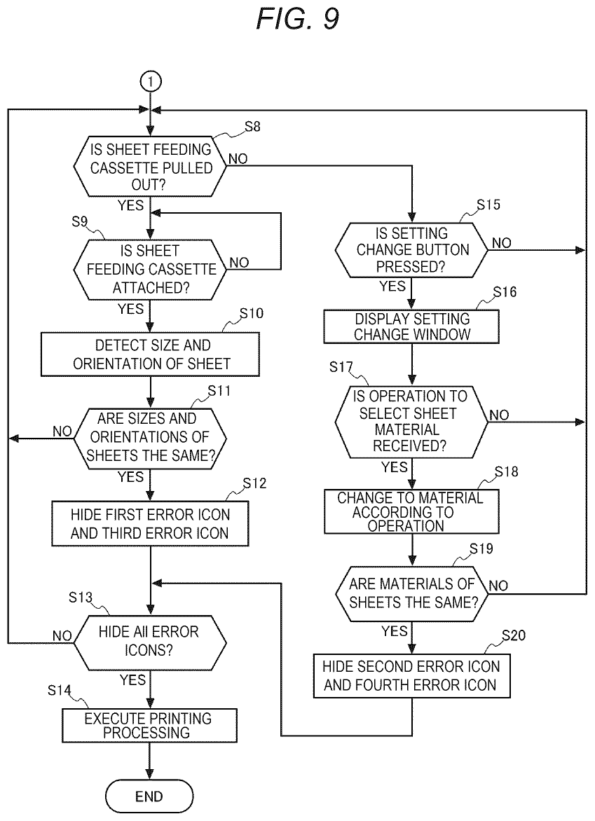

FIGS. 8 and 9 are flowcharts showing an operation of the control unit 70.

The operation of the control unit 70 will be described with reference to the flowcharts shown in FIGS. 8 and 9.

First, the control unit 70 determines whether the communication I/F 10 receives a job (step S1). When the communication I/F 10 does not receive a job (step S1/NO), the control unit 70 waits until a job is received.

When the communication I/F 10 receives the job (step S1/YES), the control unit 70 determines whether the size and orientation of the sheet contained in the job setting information of the received job and the size and orientation of the sheet contained in the cassette setting information are the same (step S2).

When the size and orientation of the sheet in the job setting information and the size and orientation of the sheet in the cassette setting information are different (step S2/NO), the control unit 70 displays the status window 200 on the touch panel 20 to display the first error icon 231 and the third error icon 251 (step S3).

When the size and orientation of the sheet in the job setting information and the size and orientation of the sheet in the cassette setting information are the same (step S2/YES), or after executing the processing at step S3, the control unit 70 goes to a determination at step S4. The control unit 70 determines whether the material of the sheet of the job setting information and the material of the sheet of the cassette setting information are the same (step S4).

When the material of the sheet in the job setting information and the material of the sheet in the cassette setting information are different (step S4/NO), the control unit 70 displays the second error icon 233 and the fourth error icon 253 (step S5). When the status window 200 is not displayed on the touch panel 20, the control unit 70 displays the status window 200, and displays the second error icon 233 and the fourth error icon 253.

Then, when at least one of the determinations at steps S2 and S4 is negative, the control unit 70 determines whether the status window 200 is displayed on the touch panel 20 (Step S6). When the status window 200 is not displayed on the touch panel 20 (step S6/NO), the control unit 70 executes the received job to execute printing processing of printing an image on a sheet (step S7).

Next, the operation of the control unit 70 when the status window 200 is displayed on the touch panel 20 (step S6/YES) will be described with reference to the flowchart shown in FIG. 9.

In the following description, it is assumed that the determination at step S2 and the determination at step S4 are both negative and the first error icon 231, the second error icon 233, the third error icon 251A, and the fourth error icon 253A are displayed in the status window 200 as shown in FIG. 2.

First, the control unit 70 determines whether the sheet feeding cassette 60 is pulled out from the main body of the multifunction peripheral 1 based on a detection result of the open/close detection sensor 61 (step S8). When a determination that the sheet feeding cassette 60 is pulled out from the main body of the multifunction peripheral 1 is made (step S8/YES), the control unit 70 determines whether the sheet feeding cassette 60 is attached to the main body of the multifunction peripheral 1 (step S9). Whether the sheet feeding cassette 60 is attached to the main body of the multifunction peripheral 1 is determined based on the detection result of the open/close detection sensor 61 (step S9).

When the sheet feeding cassette 60 is not attached to the main body of the multifunction peripheral 1 (step S9/NO), the control unit 70 returns to the determination at step S9. When the sheet feeding cassette 60 is attached to the main body of the multifunction peripheral 1 (step S9/YES), the control unit 70 detects the size and orientation of the sheet held in the sheet feeding cassette 60 by the size detection sensor 63 (step S10).

Then, the control unit 70 determines whether the detected size and orientation of the sheet are the same as the size and orientation of the sheet in the job setting information (step S11). When the detected size and orientation of the sheet is different from the size and orientation of the sheet in the job setting information are different (step S11/NO), the control unit 70 returns to the determination at step S8.

When the detected size and orientation of the sheet are the same as the size and orientation of the sheet in the job setting information (step S11/YES), the control unit 70 updates the cassette setting information of the corresponding sheet feeding cassette 60. Then, as shown in FIG. 4, the control unit 70 hides the first error icon 231 and the third error icon 251 (step S12). When the second error icon 233 and the fourth error icon 253 are hidden at step S20, the first error icon 231, the second error icon 233, the third error icon 251, and the fourth error icon 253 are all hidden as shown in FIG. 5.

Then, the control unit 70 determines whether all the error icons of the first error icon 231, the second error icon 233, the third error icon 251, and the fourth error icon 253 are hidden (step S13).

When all the error icons are hidden (step S13/YES), the control unit 70 executes the received job to execute printing processing of printing an image on a sheet (step S14).

When not all the error icons are hidden (step S13/NO), the control unit 70 returns to the determination at step S8.

Next, an operation when a determination that the sheet feeding cassette 60 is not pulled out from the main body of the multifunction peripheral 1 is made in the determination at step S8 will be described.

The control unit 70 determines whether the setting change button 255 displayed in the status window 200 is pressed (step S15).

When the setting change button 255 is pressed (step S15/YES), the control unit 70 displays the setting change window 300 on the touch panel 20 (step S16). Then, the control unit 70 determines whether an operation of changing the material of the sheet is received (step S17).

When the second display field 330 is selected by a touch operation, the control unit 70 displays the list window 400 that displays a list of selectable sheet materials. The control unit 70 determines whether an operation of selecting one of the sheet materials displayed in the list window 400 is received (step S17). When the operation of selecting one of the sheet materials is not received (step S17/NO), the control unit 70 waits until the operation of selecting the material is received.

When the sheet material displayed in the list window 400 is selected by the touch operation and the enter button 420 is pressed, the control unit 70 determines that the operation of selecting the sheet material is received (step S17/YES). When receiving the operation of selecting the sheet material (step S17/YES), the control unit 70 changes the sheet material of the corresponding cassette setting information to the sheet material selected by the operation (step S18).

Then, the control unit 70 determines whether the changed sheet material of the cassette setting information is the same as the sheet material of the job setting information (step S19). When the changed sheet material of the cassette setting information is different from the sheet material of the job setting information (step S19/NO), the control unit 70 returns to the determination at step S8.

When the changed sheet material of the cassette setting information is the same as the sheet material of the job setting information (step S19/YES), the control unit 70 hides the second error icon 233 and the fourth error icon 253 as shown in FIG. 3 (step S20). When the first error icon 231 and the third error icon 251 are hidden at step S12, the first error icon 231, the second error icon 233, the third error icon 251, and the fourth error icon 253 are all hidden as shown in FIG. 5.

Then, the control unit 70 determines whether all the error icons are hidden (step S13). When all the error icons are hidden (step S13/YES), the control unit 70 executes the received job to execute printing processing of printing an image on a sheet (step S14). When all the error icons are not hidden (step S13/NO), the control unit 70 returns to the determination step S8.

### 3. Summary of Present Disclosure

A summary of the present disclosure is appended below.

### Appendix 1

A printing apparatus includes a display unit, a receiving unit receiving a print request, a medium container unit holding a printing medium, a size detection unit detecting a size of the printing medium held in the medium container unit, and a control unit controlling the display unit to display a first display relating to the size of the printing medium and a second display relating to a material of the printing medium, wherein, when the print request to designate a first size as the size of the printing medium and designate a first material as the material of the printing medium is received and the size of the printing medium held in the medium container unit is a second size and a material of the printing medium is a second material, the control unit displays the first display in one of a first mode and a second mode different from the first mode based on the first size and the second size, and the control unit displays the second display in one of a third mode and a fourth mode different from the third mode based on the first material and the second material.

According to the configuration, the first display is displayed in one of the first mode and the second mode different from the first mode based on the first size as the size of the printing medium designated by the print request and the second size as the size of the printing medium held in the medium container unit.

Further, the second display is displayed in one of the third mode and the fourth mode different from the third mode based on the first material as the material of the printing medium designated by the print request and the second material as the material of the printing medium held in the medium container unit. Accordingly, whether the size and material of the printing medium designated by the print request are the same as the size and material of the printing medium held in the medium container unit is displayed on the display unit. Therefore, the convenience for the user can be increased.

### Appendix 2

A printing apparatus includes a display unit, a receiving unit receiving a print request, a medium container unit holding a printing medium, a size detection unit detecting a size of the printing medium held in the medium container unit, and a control unit controlling the display unit to display a first display relating to the size of the printing medium and a second display relating to a material of the printing medium, wherein, when the print request to designate a first size as the size of the printing medium and designate a first material as the material of the printing medium is received and the size of the printing medium held in the medium container unit is a second size different from the first size and a material of the printing medium is a second material different from the first material, the control unit displays the first display in a second mode and displays the second display in a fourth mode, when the size detection unit detecting the size of the printing medium held in the medium container unit detects that the size of the printing medium held in the medium container unit is changed from the second size to the first size, the control unit continues the display of the second display in the fourth mode and changes the mode of the first display from the second mode to a first mode different from the second mode, and when a setting of the material of the printing medium held in the medium container unit is changed from the second material to the first material, the control unit continues the display of the first display in the first mode and changes the mode of the second display from the fourth mode to a third mode different from the fourth mode.

According to the configuration, when the size and material of the printing medium held in the medium container unit and the size and material of the printing medium designated by the received job are different from each other, the first display relating to the size of the printing medium is displayed in the second mode and the second display relating to the material of the printing medium is displayed in the fourth mode. Thereby, the user may be notified that the size and material of the printing medium held in the medium container unit and the size and material of the printing medium designated by the received job are different from each other.

Further, when the size detection unit detects that the size of the printing medium held in the medium container unit is changed from the second size to the first size, the mode of the first display relating to the size of the printing medium is changed from the second mode to the first mode different from the second mode. Accordingly, the user may be notified that the size of the printing medium held in the medium container unit and the size of the printing medium designated by the received job are the same.

Furthermore, when a reception unit receiving an operation receives an operation of changing the material of the printing medium held in the medium container unit from the second material to the first material, the mode of the second display relating to the material of the printing medium is changed from the third mode to the fourth mode different from the third mode. Accordingly, the user may be notified that the material of the printing medium held in the medium container unit and the material of the printing medium designated by the received job are the same.

### Appendix 3

The printing apparatus according to Appendix 1 or 2, further includes a reception unit receiving an operation, and a memory unit storing setting information for correlating a second size as the size of the printing medium detected by the size detection unit to a second material as a material of the printing medium, wherein the control unit displays the second size and the second material on the display unit, and updates the second material stored as the setting information by the memory unit based on the operation received by the reception unit.

According to the configuration, the second material contained in the setting information is updated based on the operation received by the reception unit. Therefore, when the material of the printing medium held in the medium container unit is changed, the user changes the material of the printing medium held in the setting information to the material corresponding to the material of the printing medium held in the medium container unit by operating the reception unit.

### Appendix 4

In the printing apparatus according to any one of Appendices 1 to 3, the first display includes the first size, a first object displayed to accompany the first size, the second size, and a second object displayed to accompany the second size, and the control unit displays the first object and the second object in the first mode when the first size and the second size are the same, and displays the first object and the second object in the second mode when the first size and the second size are different.

According to the configuration, when the first size and the second size are the same, the first object and the second object are displayed in the first mode. When the first size and the second size are different, the first object and the second object are displayed in the second mode. Accordingly, whether the size of the printing medium designated by the job is the same as the size of the printing medium held in the medium container unit may be checked by the mode of the first object and the second object. Therefore, the convenience for the user can be increased.

### Appendix 5

In the printing apparatus according to any one of Appendices 1 to 4, the second display includes the first material, a third object displayed to accompany the first material, the second material, and a fourth object displayed to accompany the second material, and the control unit displays the third object and the fourth object in the third mode when the first material and the second material are the same, and displays the third object and the fourth object in the fourth mode when the first material and the second material are different.

According to the configuration, when the first material and the second material are the same, the third object and the fourth object are displayed in the third mode. When the first material and the second material are different, the third object and the fourth object are displayed in the fourth mode. Accordingly, whether the material of the printing medium designated by the job is the same as the material of the printing medium held in the medium container unit may be checked by the mode of the third object and the fourth object. Therefore, the convenience for the user can be increased.

### Appendix 6

The printing apparatus according to Appendix 4 further includes a reception unit receiving an operation, and a plurality of the medium container units, wherein the control unit displays the second size in a size corresponding to the size of the printing medium held in each of the plurality of medium container units, the control unit displays the second size and the second object as the first display corresponding to the medium container unit selected through the operation received by the reception unit, and the control unit displays the second size as the first display corresponding to the medium container unit unselected through the operation received by the reception unit.

According to the configuration, the second size and the second object are displayed as the first display corresponding to the medium container unit selected by the operation received by the reception unit, and the second size is displayed as the first display of the medium container unit unselected through the operation received by the reception unit. Accordingly, the second object is displayed only in the first display corresponding to the medium container unit selected by the user. Therefore, the medium container unit used for printing may be easily checked. Further, the second object is not displayed for the medium container unit not used for printing, and thereby, the number of displays of unnecessary information may be reduced.

### Appendix 7

The printing apparatus according to Appendix 5 further includes a reception unit receiving an operation, and a plurality of the medium container units, wherein the control unit displays the second material with a material corresponding to the size of the printing medium held in each of the plurality of medium container units, the control unit displays the second material and the fourth object as the second display corresponding to the medium container unit selected through the operation received by the reception unit, and the control unit displays the second material as the second display corresponding to the medium container unit unselected through the operation received by the reception unit.

According to the configuration, the second material and the fourth object are displayed as the second display corresponding to the medium container unit selected through the operation received by the reception unit, and the second material is displayed as the second display of the medium container unit unselected through the operation received by the reception unit.

Accordingly, the fourth object is displayed only in the second display corresponding to the medium container unit selected by the user. Therefore, the medium container unit used for printing may be easily checked. Further, the fourth object is not displayed for the medium container unit not used for printing, and thereby, the number of displays of unnecessary information may be reduced.

### Appendix 8

The printing apparatus according to Appendix 6 further includes a memory unit storing setting information for correlating the second size as the size of the printing medium detected by the size detection unit to the second material as the material of the printing medium, wherein, when the control unit displays the first object and the second object in the second mode, the control unit displays the second size, the second object, and a guidance display for promoting a change of the setting information as the first display corresponding to the medium container unit selected through the operation received by the reception unit.

According to the configuration, the second size, the second object, and the guidance display for promoting a change of the setting information are displayed as the first display corresponding to the medium container unit selected through the operation received by the reception unit. Therefore, the user can change the setting information.

### Appendix 9

The printing apparatus according to Appendix 7 further includes a memory unit storing setting information for correlating the second size as the size of the printing medium detected by the size detection unit to the second material as the material of the printing medium, wherein, when the control unit displays the third object and the fourth object in the third mode, the control unit displays the second material, the fourth object, and a guidance display for promoting a change of the setting information as the second display corresponding to the medium container unit selected through the operation received by the reception unit.

According to the configuration, the second material, the fourth object, and the guidance display for promoting a change of the setting information are displayed as the second display corresponding to the medium container unit selected through the operation received by the reception unit. Therefore, the user can change the setting information.

The above described embodiments are preferred embodiments. The present disclosure is not limited to the above described embodiments, but various modifications can be made without departing from the scope of the present disclosure.

For example, it is assumed that at least one of the size, the orientation, and the material of the sheet contained in the job setting information and the size, the orientation, and the material of the sheet contained in the cassette setting information are different, and at least one of the first error icon 231 and the second error icon 233 of the second display field 230 is displayed and at least one of the third error icon 251 and the fourth error icon 253 of the third display field 250 is displayed.

In this case, the control unit 70 may display or hide the setting change button 255 displayed in the third display field 250 corresponding to the sheet feeding cassette 60 feeding the sheet as a guidance display for the user to change at least one setting of the size, the orientation, and the material of the sheet.

The display color of the setting change button 255 displayed in the third display field 250 corresponding to the sheet feeding cassette 60 set to feed the sheet may be displayed in a display color different from the display color of the setting change button 255 displayed in the third display field 250 corresponding to the other sheet feeding cassette 60 set not to feed the sheet.

In the above described embodiments, the case where the printing medium is a sheet held in the sheet feeding cassette 60 is described, however, the printing medium may be a roll of paper.

Functional units of the multifunction peripheral 1 shown in FIG. 1 show a functional configuration, and a specific implementation form is not particularly limited. That is, hardware individually corresponding to each functional unit is not necessarily mounted and, obviously, the plurality of functional units may be implemented by one or more processors executing programs. In the above described embodiments, part of functions implemented by software may be implemented by hardware, or part of functions implemented by hardware may be implemented by software.

Units of processing in the flowcharts shown in FIGS. 8 and 9 are divided according to details of the main processing for facilitation of understanding of the processing by the multifunction peripheral 1. The present disclosure is not limited by a way of dividing the units and names of processing shown in the flowcharts of FIGS. 8 and 9. The processing by the multifunction peripheral 1 may be divided into more units of processing according to the details of processing, or divided so that a single unit of processing may be divided to include more processing. Further, the above described sequences of processing of the flowcharts are not limited to those of the illustrated examples.

What is claimed is:

1. A printing apparatus comprising:
a display unit;
a receiving unit receiving a print request;
a medium container unit holding a printing medium;
a size detection unit detecting a size of the printing medium held in the medium container unit; and
a control unit controlling the display unit to display a first display relating to the size of the printing medium and a second display relating to a material of the printing medium, wherein
when the print request to designate a first size as the size of the printing medium and designate a first material as the material of the printing medium is received and the size of the printing medium held in the medium container unit is a second size and a material of the printing medium is a second material,
the control unit displays the first display in one of a first mode and a second mode different from the first mode based on the first size and the second size, and
the control unit displays the second display in one of a third mode and a fourth mode different from the third mode based on the first material and the second material.

2. A printing apparatus comprising:
a display unit;
a receiving unit receiving a print request;
a medium container unit holding a printing medium;
a size detection unit detecting a size of the printing medium held in the medium container unit; and
a control unit controlling the display unit to display a first display relating to the size of the printing medium and a second display relating to a material of the printing medium, wherein
when the print request to designate a first size as the size of the printing medium and designate a first material as the material of the printing medium is received and the size of the printing medium held in the medium container unit is a second size different from the first size and a material of the printing medium is a second material different from the first material,
the control unit displays the first display in a second mode and displays the second display in a fourth mode,
when the size detection unit detecting the size of the printing medium held in the medium container unit detects that the size of the printing medium held in the medium container unit is changed from the second size to the first size,
the control unit continues the display of the second display in the fourth mode and changes the mode of the first display from the second mode to a first mode different from the second mode, and
when a setting of the material of the printing medium held in the medium container unit is changed from the second material to the first material,
the control unit continues the display of the first display in the first mode and changes the mode of the second display from the fourth mode to a third mode different from the fourth mode.

3. The printing apparatus according to claim 1, further comprising:
a reception unit receiving an operation; and
a memory unit storing setting information for correlating a second size as the size of the printing medium detected by the size detection unit to the second material as a material of the printing medium, wherein
the control unit displays the second size and the second material on the display unit, and updates the second material stored as the setting information by the memory unit based on the operation received by the reception unit.

4. The printing apparatus according to claim 1, wherein
the first display includes the first size, a first object displayed to accompany the first size, the second size, and a second object displayed to accompany the second size, and
the control unit displays the first object and the second object in the first mode when the first size and the second size are the same, and displays the first object and the second object in the second mode when the first size and the second size are different.

5. The printing device according to claim 1, wherein
the second display includes the first material, a third object displayed to accompany the first material, the second material, and a fourth object displayed to accompany the second material, and
the control unit displays the third object and the fourth object in the third mode when the first material and the second material are the same, and displays the third object and the fourth object in the fourth mode when the first material and the second material are different.

6. The printing apparatus according to claim 4, further comprising:
a reception unit receiving an operation; and
a plurality of the medium container units, wherein
the control unit displays the second size in a size corresponding to the size of the printing medium held in each of the plurality of medium container units,
the control unit displays the second size and the second object as the first display corresponding to the medium container unit selected through the operation received by the reception unit, and
the control unit displays the second size as the first display corresponding to the medium container unit unselected through the operation received by the reception unit.

7. The printing apparatus according to claim 5, further comprising:
a reception unit receiving an operation; and
a plurality of the medium container units, wherein
the control unit displays the second material with a material corresponding to the size of the printing medium held in each of the plurality of medium container units,
the control unit displays the second material and the fourth object as the second display corresponding to the medium container unit selected through the operation received by the reception unit, and
the control unit displays the second material as the second display corresponding to the medium container unit unselected through the operation received by the reception unit.

8. The printing apparatus according to claim 6, further comprising a memory unit storing setting information for correlating the second size as the size of the printing medium detected by the size detection unit to the second material as the material of the printing medium, wherein
when the control unit displays the first object and the second object in the second mode,
the control unit displays the second size, the second object, and a guidance display for promoting a change of the setting information as the first display corresponding to the medium container unit selected through the operation received by the reception unit.

9. The printing apparatus according to claim 7, further comprising a memory unit storing setting information for correlating the second size as the size of the printing medium detected by the size detection unit to the second material as the material of the printing medium, wherein
when the control unit displays the third object and the fourth object in the third mode,
the control unit displays the second material, the fourth object, and a guidance display for promoting a change of the setting information as the second display corresponding to the medium container unit selected through the operation received by the reception unit.
